(19) United States
(12) Patent Application Publication
(10) Pub. No.: US 2005/0286996 A1
(43) Pub. Date: Dec. 29, 2005

(54) Wind-guiding device for windmill generator

(76) Inventor: Kun-Lung Tsai, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/878,028

(22) Filed: Jun. 29, 2004

(51) Int. Cl. F03B 15/06

(52) U.S. Cl. 415/4.2

(57) ABSTRACT

A windmill generator includes a wind-driven unit, a generating unit, and a wind-guiding device. The wind-driven unit includes a blade device with a plurality of blades and a shaft securely extending through the blade device to turn therewith. The generating unit is connected to the shaft. The wind-guiding device includes a rotary member rotatably mounted to the shaft, two wind plates respectively and securely mounted on two ends of the rotary member to turn therewith, and a wind-guiding housing rotatably mounted to the shaft. The wind-guiding housing guides the wind to a direction for driving an associated one of the blades of the wind-driven unit.

### BACKGROUND OF THE INVENTION

1. Field of the Invention

The present invention relates to a wind-guiding device for a windmill generator. In particular, the present invention relates to a wind-guiding device for guiding the wind to a direction effectively driving a wind-driven unit of a windmill generator.

2. Description of the Related Art

Windmill generators are recommended by environment-protecting parties to replace generators that generate electricity through fire, water, nuclear energy, and solar energy. FIG. 1 of the drawings illustrates a conventional windmill generator 1 comprising a wind-driven unit 11 and a generating unit 12. The generating unit 12 is mounted on a base 13 or a high rise. The wind-driven unit 11 includes a blade means 111 having a plurality of blades 112. The blade means 111 is mounted on a shaft 13 to turn therewith, and the shaft 13 is connected to the generating unit 12. When the wind blows, the blade means 111 and the shaft 13 turn to actuate the generating unit 12, thereby generating electricity. However, the flowing direction of the wind and the wind power always change and thus could not be controlled and effectively used.

### SUMMARY OF THE INVENTION

In accordance with an aspect of the present invention, a windmill generator comprises a wind-driven unit, a generating unit, and a wind-guiding device. The wind-driven unit includes a blade means and a shaft securely extending through the blade means to turn therewith. The blade means includes a plurality of blades. The generating unit is connected to the shaft. The wind-guiding device includes a rotary member rotatably mounted to the shaft, two wind plates respectively and securely mounted on two ends of the rotary member to turn therewith, and a wind-guiding housing rotatably mounted to the shaft. The wind-guiding housing guides the wind to a direction for driving an associated one of the blades of the blade means of the wind-driven unit.

In an embodiment of the invention, the rotary member is a rod. The wind-guiding housing is securely connected to a central portion of the rotary member to turn therewith. Each wind plate may be planar or arcuate. The wind-guiding housing is semispherical and includes a plurality of annularly spaced arcuate wind-guiding plates. The wind-guiding housing includes a common top plate, and each arcuate wind-guiding plate has an upper end connected to the common top plate. The wind-guiding housing includes a common bottom plate, and each arcuate wind-guiding plate has a lower end connected to the common bottom plate.

In another embodiment of the invention, one of the wind plates is above the rotary member and the other wind plate is below the rotary member.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view, partly cutaway, of a conventional windmill generator.

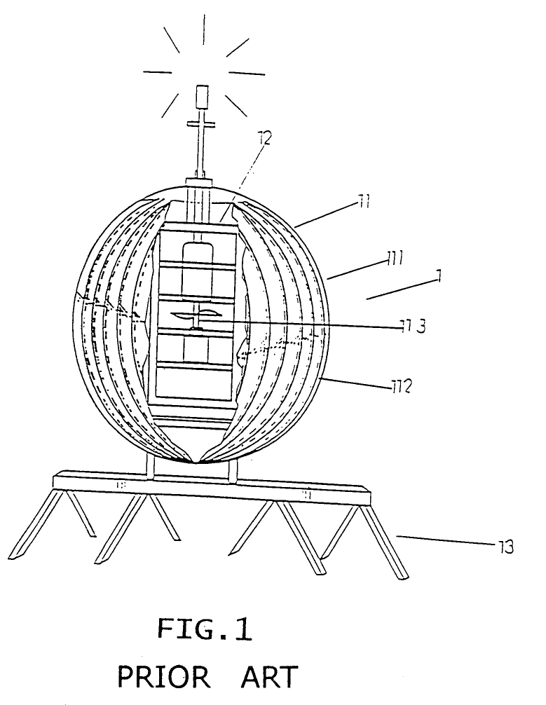

FIG. 2 is an exploded perspective view of a windmill generator in accordance with the present invention.

FIG. 3 is a perspective view of the windmill generator in accordance with the present invention.

FIG. 4 is a perspective view of the windmill generator mounted on a high-rise base.

FIG. 5 is a perspective view of the windmill generator mounted on a low base.

FIG. 6 is a sectional view of the windmill generator in accordance with the present invention.

FIG. 7 is a sectional view illustrating guiding of the wind by a wind-guiding device of the windmill generator.

FIG. 8 is another sectional view of the windmill generator.

FIG. 9 is a perspective view illustrating a modified embodiment of the windmill generator.

FIG. 10 is a perspective view illustrating another modified embodiment of the windmill generator.

### DETAILED DESCRIPTION OF THE PREFERRED EMBODIMENTS

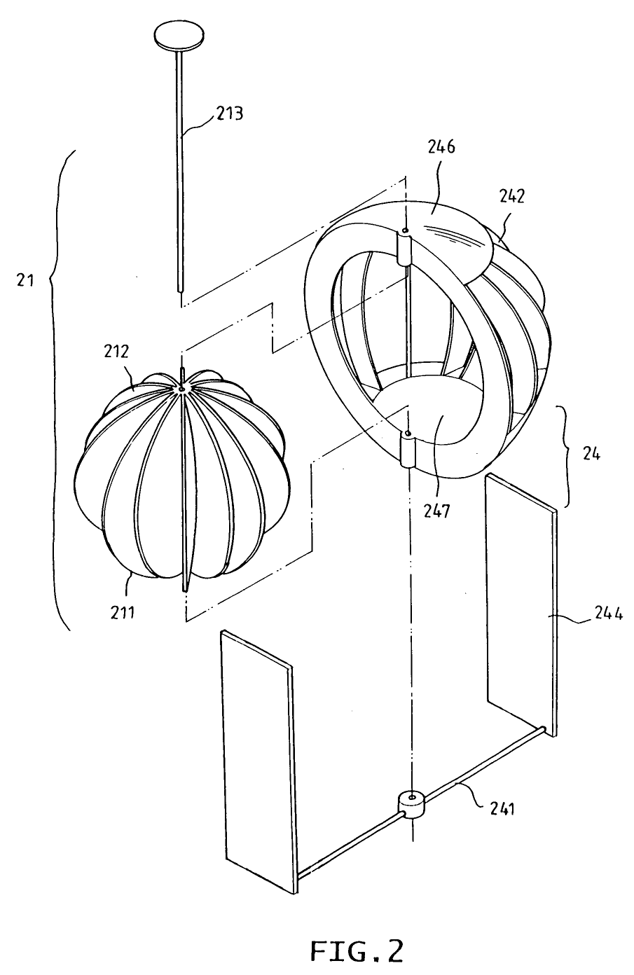

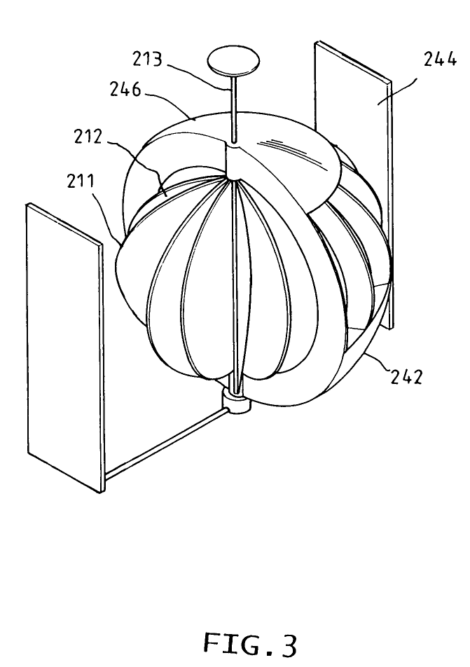

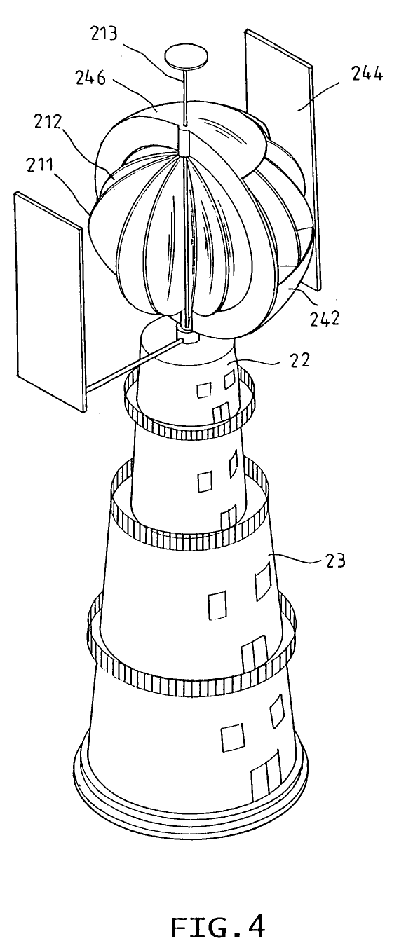

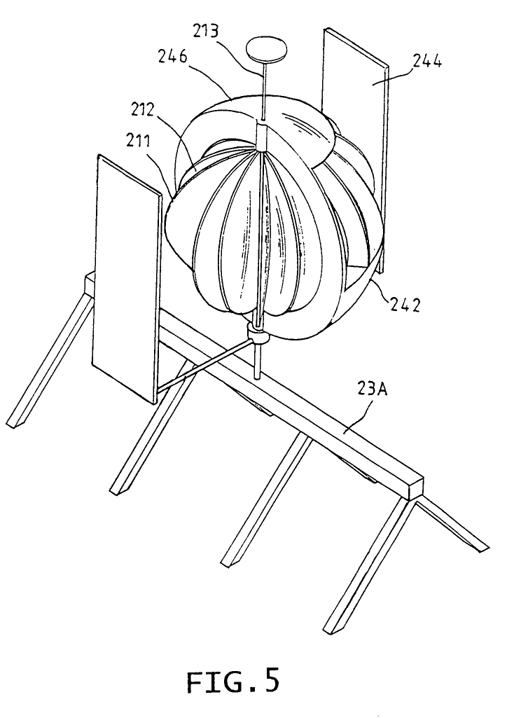

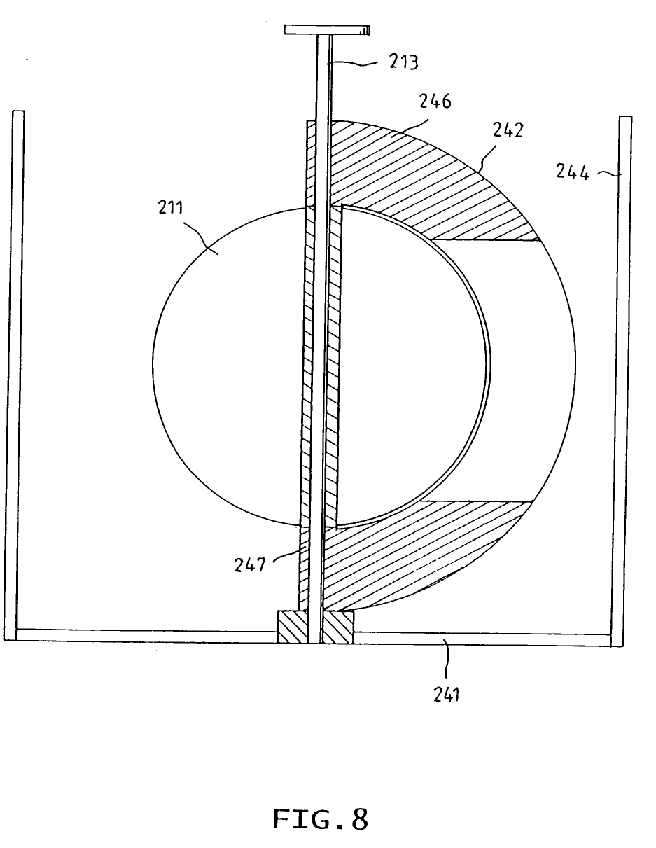

Referring to FIGS. 2, 3, and 8, a windmill generator 2 in accordance with the present invention comprises a wind-driven unit 21 that can be driven by wind. The windmill generator 2 further includes a generating unit 22 that is conventional and thus not described in detail. The generating unit 22 can be mounted on a high-rise base 23 (FIG. 4) or a lower base 23A (FIG. 5).

The wind-driven unit 21 comprises a blade means 211 having a plurality of blades 212 and a shaft 213 extending through the blade means 211, allowing joint rotation of the blade means 211 and the shaft 213. The shaft 213 is connected to the generating unit 22 such that rotation of the shaft 213 causes the generating unit 22 to generate electricity, which is conventional and therefore not described in detail.

The windmill generator 2 further comprises a wind-guiding device 24 including a rotary member 241, a wind-guiding housing 242, and two wind plates 244. The rotary member 241 is rotatably mounted to the shaft 213. In this embodiment, the rotary member 241 is a rod, with two ends of the rod being located on two diametrically opposed sides of the shaft 213, and with the wind plates 244 being respectively and securely mounted on the ends of the rod. The wind plates 244 are planar and located above the rotary member 241.

The wind-guiding housing 242 is substantially semispherical and includes a plurality of angularly spaced arcuate wind-guiding plates 243. Each arcuate wind-guiding plate 243 has an upper end connected to a common top plate 246 and a lower end connected to a common bottom plate 247. The shaft 213 is rotatably extended through the wind-guiding housing 242. Namely, the wind-guiding housing 242 is rotatable relative to the shaft 213, while the blade means 211 of the wind-driven unit 21 turns together with the shaft 213. The wind-guiding housing 242 is securely connected to a central portion of the rotary member 241 to turn therewith.

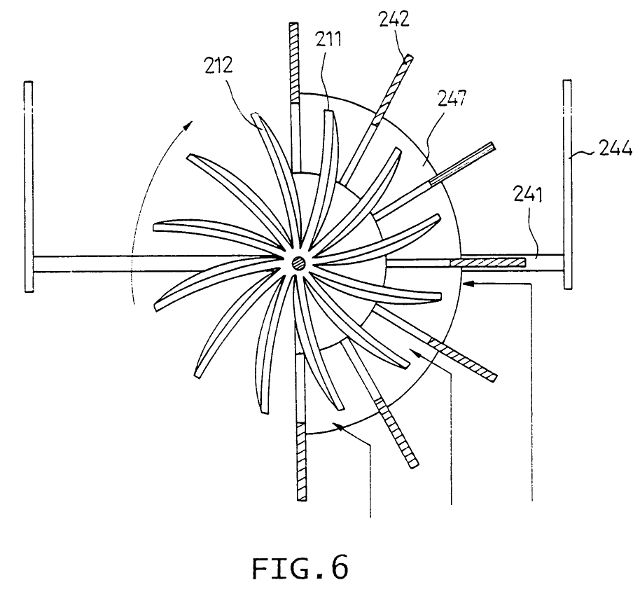

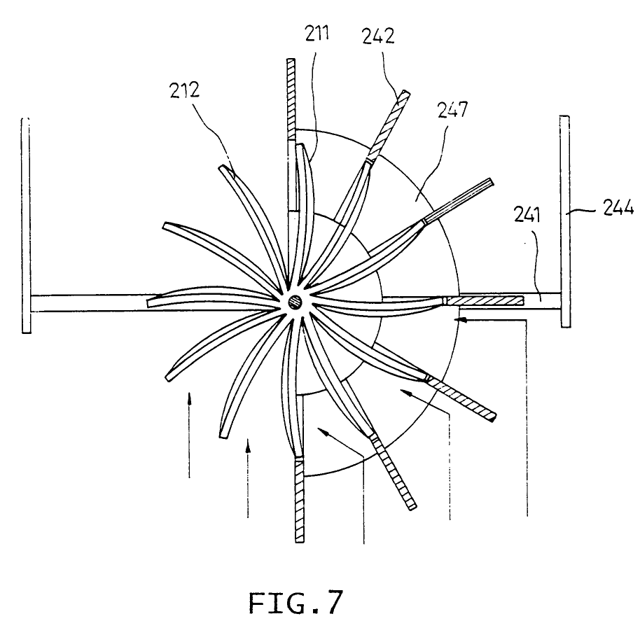

When in use, the wind plates 244 and the wind-guiding housing 242 will be moved by the wind to a position shown in FIGS. 6 and 7 under the wind power. Thus, the wind plates 244 may concentrate the wind. Further, the speed of the wind passing through the space between the wind plates 244 is increased due to tunnel effect. The blade means 211 and the wind-guiding housing 242 are located between the wind plates 244 and thus subjected to greater wind power.

Further, as illustrated in FIGS. 6 and 7, the flowing direction of a portion of the wind entering a space between two adjacent arcuate wind-guiding plates 247 is changed by one of the two adjacent arcuate wind-guiding plates 247 to another flowing direction capable of pushing an associated one of the blades 212 of the wind-driven unit 21. Thus, almost every portion of the wind can be guided to drive an associated blade 212 of the wind-driven unit 21. The overall driving force imparted to the wind-driven unit 21 is greater than that of the conventional windmill generator without the wind-guiding housing 242.

The blades 212 of the blade means 21 of the wind-driven unit 2 may have any desired shape. The blades 212 are distributed over a complete circle when viewed in section. Rotation of the shaft 213 and the blade means 21 causes the generating unit 22 to generate electricity.

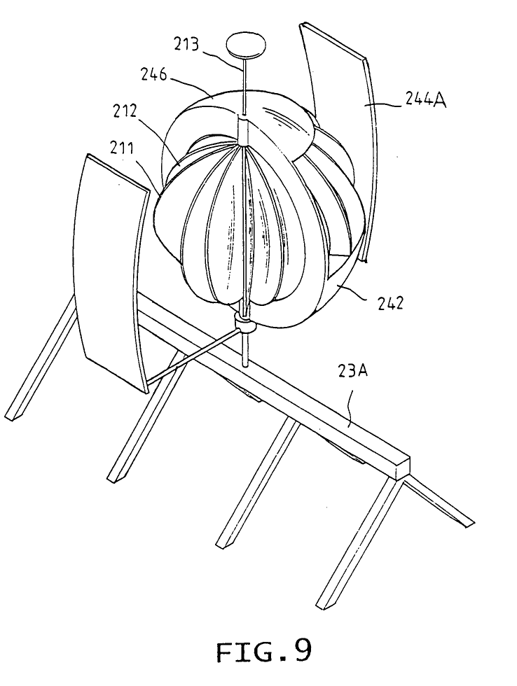

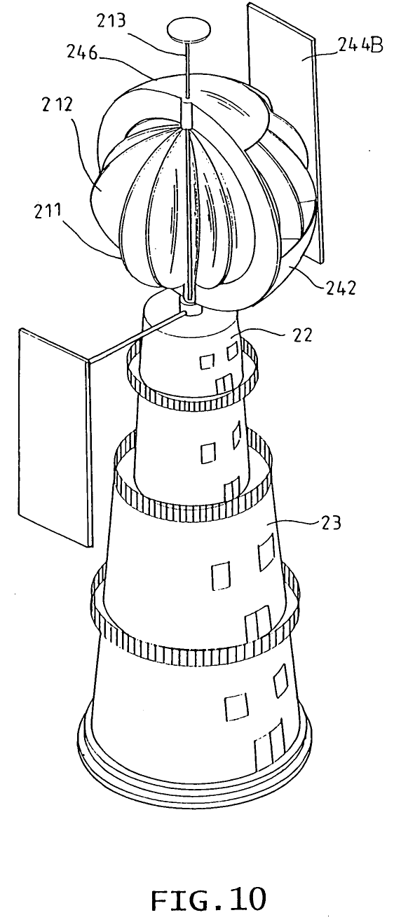

FIG. 9 shows a modified embodiment of the invention, wherein each wind plate (now designated by 244A) is arcuate. FIG. 10 shows another modified embodiment of the invention, wherein one of the wind plates (now designated by 244B) is above the rotary member 241, and the other wind plate 244B is below the rotary member 241.

Although the invention has been explained in relation to its preferred embodiment, it is to be understood that many other possible modifications and variations can be made without departing from the scope of the invention as hereinafter claimed.

1. A windmill generator comprising:
a wind-driven unit including a blade means and a shaft securely extending through the blade means to turn therewith, the blade means including a plurality of blades;
a generating unit connected to the shaft; and
a wind-guiding device comprising:
a rotary member rotatably mounted to the shaft and including two ends;
two wind plates respectively and securely mounted on the ends of the rotary member to turn therewith; and
a wind-guiding housing rotatably mounted to the shaft, the wind-guiding housing guiding wind to a direction for driving an associated one of the blades of the blade means of the wind-driven unit.

2. The windmill as claimed in claim 1, wherein the rotary member is a rod.

3. The windmill as claimed in claim 1, wherein the wind-guiding housing is securely connected to a central portion of the rotary member to turn therewith.

4. The windmill as claimed in claim 1, wherein each said wind plate is planar.

5. The windmill as claimed in claim 1, wherein the wind-guiding housing is semispherical and includes a plurality of annularly spaced arcuate wind-guiding plates.

6. The windmill as claimed in claim 5, wherein the wind-guiding housing includes a common top plate, and wherein each said arcuate wind-guiding plate has an upper end connected to the common top plate.

7. The windmill as claimed in claim 5, wherein the wind-guiding housing includes a common bottom plate, and wherein each said arcuate wind-guiding plate has a lower end connected to the common bottom plate.

8. The windmill as claimed in claim 1, wherein each said wind plate is arcuate.

9. The windmill as claimed in claim 1, wherein one of the wind plates is above the rotary member and the other wind plate is below the rotary member.
